(19) United States
(12) Patent Application Publication
(10) Pub. No.: US 2016/0288027 A1
(43) Pub. Date: Oct. 6, 2016

(54) REMOVAL APPARATUS FOR GREEN ALGAE

(71) Applicants: YOENG MO CHOI, (US); CHEONGHO ENVIRONMENT INDUSTRY CO., LTD, Changwon-si (KR)

(72) Inventor: YOENG MO CHOI, Changwon-si (KR)

(21) Appl. No.: 14/830,697

(22) Filed: Aug. 19, 2015

(30) Foreign Application Priority Data
Apr. 6, 2015 (KR) 10-2015-0048663

(51) Int. Cl. B01D 33/06; B01D 33/48; C02F 1/00

(52) U.S. Cl. CPC B01D 33/06; C02F 1/004; B01D 33/48

(57) ABSTRACT

The present invention relates to a removal apparatus for green algae capable of persistently removing the green algae floating in water and which is easy to manufacture and manage because of its simple structure. The removal apparatus for green algae comprises a screen unit that pulls the green algae out of the water by rotation as a part thereof is submerged into the water; a first cleaning unit that sprays air in the direction from the inside of the screen unit to the outside; a second cleaning unit that sprays air from the outside of the screen unit to the inside; a first collecting unit positioned outside of the screen unit and in which the green algae removed by the first cleaning unit is stacked; and a second collecting unit positioned inside of the screen unit and in which the green algae removed by the second cleaning unit is stacked.

### CROSS-REFERENCE TO RELATED APPLICATION

This application claims priority to and the benefit of Korean Patent Application No. 10-2015-0048663, filed on Apr. 6, 2015, the disclosure of which is incorporated herein by reference in its entirety.

### BACKGROUND OF THE INVENTION

1. Field of the Invention

The present invention relates to a removal apparatus for green algae, and more specifically, to a removal apparatus for green algae capable of persistently removing green algae floating in the water.

2. Description of the Related Art

Green algae are the phenomenon that the color of water becomes changed to green as a large quantity of planktons grows. This phenomenon is mainly caused by blue-green algae, and occurs in rivers, streams, lakes, and the like.

The blue-green algae are phytoplankton that lives in summer in the lake where the water quality is poor due to eutrophication. If a large quantity of phytoplankton grows in summer and is floating on the surface of the water, the water becomes green. This is called green algae phenomenon.

By contrast, the phenomenon that the sea becomes red due to flagella and diatoms is called red tide.

If green algae propagate, the amount of dissolved oxygen in the water is reduced, and like red tide, lots of fishes are dead, and the water reeks of a rotten smell, which causes damages to fisheries. In addition, if a person drinks the water of the green lake where there are many blue-green algae having toxin, it causes liver damage or stomachache or vomiting, and too much drinking can even lead to death.

Furthermore, the ecosystem in the sea may be destroyed, which may affect the food chain. In many cases, green algae have a bad influence, so it is also called harmful algal-bloom (HAB: including a shellfish-toxin phenomenon which causes food poisoning due to fish and shellfish).

Such green algae have already become many issues socially, and whenever the green algae are generated, the green algae have been removed temporarily by putting soil or chemicals into the water persistently.

However, recently, as the green algae phenomenon is getting worse due to the four-river project, it is becoming a social issue, and accordingly, problems such as pollution of drinking water, fish mortality, occurrence of offensive odors, etc. occur continuously.

Various apparatus and chemicals for resolving such problems have been developed, and the representative known technology is “Removal Robot for Water Bloom (Korean Patent No. 10-1224170).”

However, the removal method using chemicals is improper in terms of costs because the chemicals should be put into the water persistently, and this is just a temporary expedient. Since “removal robot for water bloom” is also very complicated in constitution, the costs for manufacturing and purchasing it are very expensive. Thus, it is difficult to apply the removal robot realistically. Furthermore, it is not suitable for use in deep rivers or river streams that is not water bloom.

In addition, since too much electricity is consumed to operate the removal robot for water bloom persistently, is difficult to apply the robot since the maintenance costs are very expensive.

### CITATION LIST

### Patent Literature

Patent Literature 1: Korean Patent No. 10-1224170 (Jan. 14, 2013)

### SUMMARY OF THE INVENTION

The object of the embodiments of the present invention is to provide a removal apparatus for green algae capable of persistently removing green algae floating in the water with minimum electricity consumption, which is easy to manufacture and maintain due to its simple structure.

### BRIEF DESCRIPTION OF THE DRAWING(S)

FIG. 1 is a drawing showing the first embodiment of the removal apparatus for green algae in which a drum-type screen unit is applied.

FIG. 2 is a drawing showing the second embodiment of the removal apparatus for green algae in which a drum-type screen unit is applied.

FIG. 3 is a drawing showing the third embodiment of the removal apparatus for green algae in which a conveyer-type screen unit is applied.

FIGS. 4, 5 and 6 are drawings showing the fourth embodiment of the removal apparatus for green algae in which a conveyer-type screen unit is applied.

### DETAILED DESCRIPTION OF THE PREFERRED EMBODIMENT(S)

Hereinafter, the embodiments of the present invention will be explained with reference to the drawings attached. The reference numerals of the background technology and the already explained elements will be used for the same elements, unless there is special reference.

The following explanation of the removal apparatus for green algae according to the present invention is the preferred embodiments of the present invention, and the present invention is not limited to the embodiments, but can be implemented in various forms.

In addition, the shapes and sizes, etc. of the respective elements that will be explained below are only representative embodiments and they various changes can be made if it embodies the same effect.

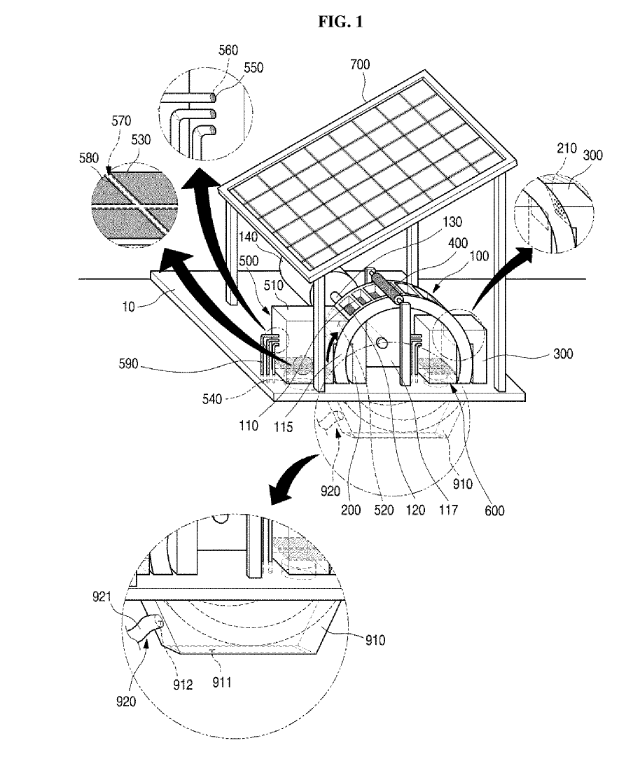

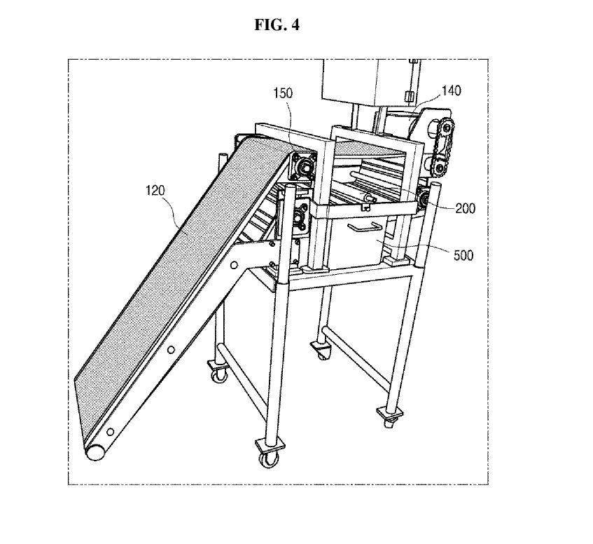

The removal apparatus for green algae according to the present invention comprises a screen unit (100), a first cleaning unit (200), a second cleaning unit (300), a first collecting unit (500), and a second collecting unit (600), as illustrated in FIGS. 1 to 4, and the removal apparatus is placed on a floating means (10) which is located above the water.

Prior to explaining the dominant constitution in detail, as the floating means (10) on which the present invention is placed, various means such as a facility fixed on the land, a ship floating on the water, etc. can be used if the removal apparatus for green algae can be placed above the water.

The screen unit (100), which has predetermined meshes (unit representing the size of a net knot of a net; this refers to the number of holes within the predetermined area), pulls green algae floating in the water out of the water as it rotates while a part thereof is positioned on the lower side of the bloating means (10) and submerged in the water. When the screen unit (100) rotates, the green algae floating in the water are adhered to the surface of the screen unit (100), thereby getting out of the water.

Such screen unit (100) has various sizes of meshes at the same time, thereby improving the adhesion with the green algae and preventing the adhered green algae from leaving.

As illustrated in FIG. 1, inside of the screen unit (100), the first cleaning unit (200) is positioned, and the first cleaning unit (200) sprays air in the direction of the inside of the screen unit (100) to the outside so as to separate the green algae, that are adhered to the screen unit (100) and are out of the water, from the screen unit (100).

Since green algae have very small particles and are viscous, they are not completely removed by the air of the first cleaning unit (200), and some of them remain in the holes of the screen unit (100). In order to remove the remaining green algae secondarily, a second cleaning unit (300) is positioned on the outside of the screen unit (100).

The second cleaning unit (300) sprays the air from the outside of the screen unit (100) to the inside so as to remove green algae which are not removed by the first cleaning unit (200) secondarily. Here, the second cleaning unit (300) sprays the air in the opposite direction to the first cleaning unit (200).

The first cleaning unit (200) and the second cleaning unit (300) can be provided opposite to each other. However, in order to maximize the cleaning effect and collect the separated green algae effectively, the first cleaning unit (200) and the second cleaning unit (300) should be preferably provided so that they can clean the different areas of the screen unit (100).

On the outside of the screen unit (100), the first collecting unit (500) in which the green algae removed by the first cleaning unit (200) are stacked is provided, and inside of the screen unit (100), the second collecting unit (600) in which the green algae removed by the second cleaning unit (300) are stacked is provided.

The green algae removed by the air are stacked with a very small amount of water in the first collecting unit (500) and the second collecting unit (600), and if the predetermined amount of the green algae is stacked, the first collecting unit (500) and the second collecting unit (600) may be separated to remove the green algae, or only a first filter unit (530) that will be explained below may be separated to remove the green algae.

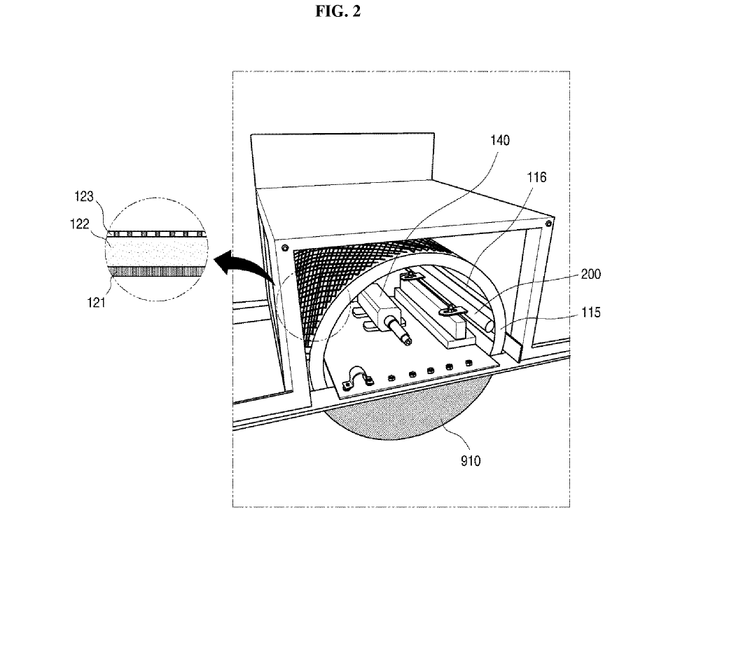

The first cleaning unit (200), the second cleaning unit (300), the first collecting unit (500) and the second collecting unit (600) can be all provided as illustrated in FIG. 1, but they can be selectively provided as illustrated in FIG. 2.

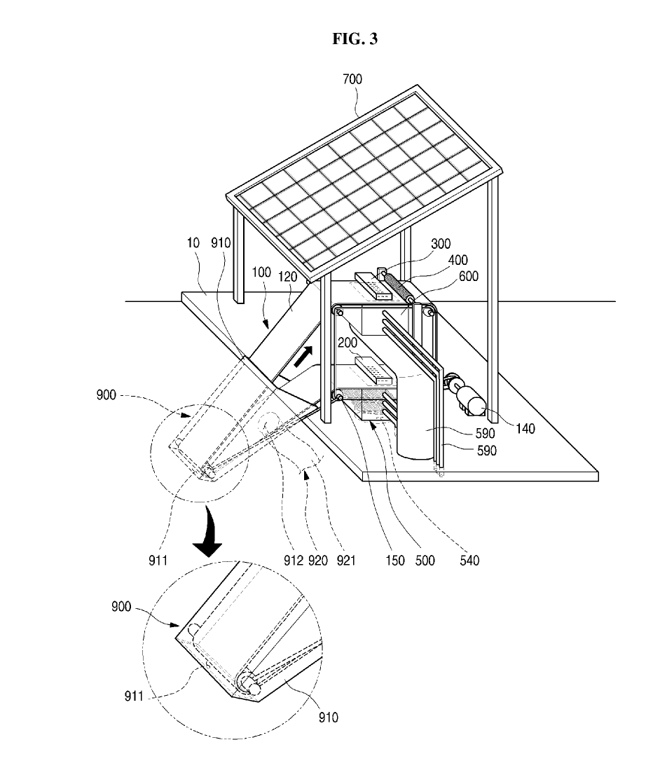

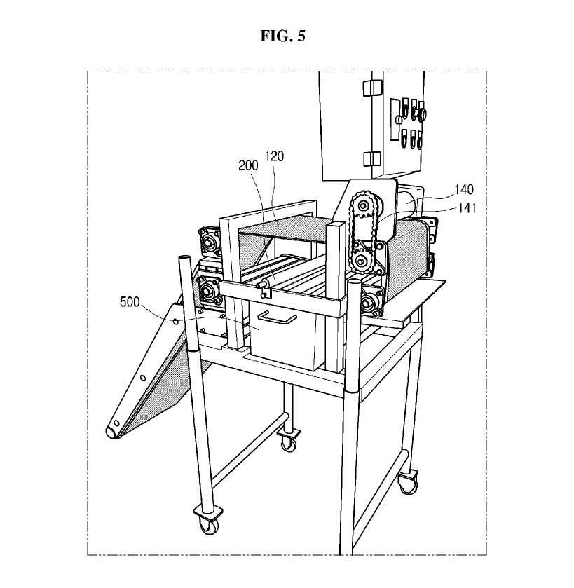

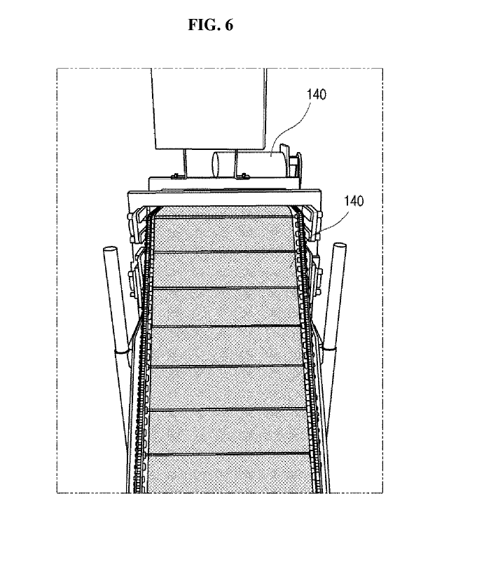

Meanwhile, the aforementioned screen unit (100) may be greatly made as a drum type as illustrated in FIGS. 1 and 2 and a conveyer type as illustrated in FIGS. 3 to 6, and the type can be selectively applied depending on the used situation and as needed. For instance, a drum-type screen unit (100) may be advantageous for use in a narrow space, and a conveyer-type screen unit (100) may be advantageous for use in a wide space.

The drum-type screen unit (100) illustrated in FIGS. 1 and 2 comprises a pair of base frames (115) that are circular and opposite to each other, a plurality of support frames (116) that are provided apart from each other at a predetermined interval according to a circumferential direction of the base frames (115) so as to connect the pair of base frames (115) and supports a mesh means (120), and the mesh means (120) having predetermined meshes that surrounds the upper surface of the plurality of support frames (116) and pulls the green algae in the water out of the water.

On one side of the base frames (115), a side frame (117) is provided and connected to the outer circumference surface of the base frames (115), and the center of the side frame (117) is connected to a rotation axis (130).

The rotation axis (130) is connected to a driving means (140), and the rotation axis (130) rotates by the operation of the driving means (140), and thereby the screen unit (100) rotates. As such driving means (140), any means including a motor can be used as long as it rotates the screen unit (100).

The screen unit (100) is placed on the upper side of the floating means (1), but a part of the base frames (115) is positioned in the lower side of the floating means (1) and is submerged in the water. Inside of the screen unit positioned on the upper side of the floating means (1), the first cleaning unit (200) and the second collecting unit (600) are positioned.

The first cleaning unit (200) and the second collecting unit (600) are always fixed, regardless of the rotation of the screen unit (100). That is, the first cleaning unit (200) sprays air from the same position towards the same direction, and the second collecting unit (600) collects the green algae removed by the second cleaning unit (300) from the same position, and the second cleaning unit (300) and the first collecting unit (500) are also fixed in position.

Since planktons, which make the green algae, are very small organisms having the size of several μm to several mm and being viscous, the mesh means (120) preferably has 50 to 400 meshes. If the mesh means (120) has less than 50 meshes, it would pass through holes formed on the screen unit (100), so the amount of the green algae adhered to the mesh means (120) would be sharply reduced. If the mesh means has more than 400 meshes, the holes of the mesh means (120) would be easily plugged because of the viscosity of the green algae, so the green algae would not be easily adhered.

If the present invention is utilized in a place such as a reservoir, since the water in which the screen unit (100) is submerged does not flow but is pooled, it is difficult to increase the effect of removing green algae to a constant level even if the mesh means (120) rotates persistently.

Thus, it is preferable to optionally comprise a water current generating unit (900) that generates the flow of water continuously on the lower side of the screen unit (100).

The water current generating unit (900) is positioned on the lower side of the floating means (10) and surrounds the screen unit (100) such that the screen unit (100) can rotate therein, and comprises a case (910) with an entrance (911) through which the water is introduced, and an outlet (912) through which the water is discharged so that the continuous flow of the water can be generated, and a suction means (920) that is connected to the outlet (912) and generates the suction force.

The suction means (920) comprises a suction pipe (921) which is connected to the outlet (912) in the outside of the case (910), and a suction pump (not shown) provided at the end of the suction pipe (921).

By virtue of such structure, when the suction pump (not shown) is operated, the water positioned inside of the case (910) is discharged through the suction pipe (921) and the outlet (912), and accordingly, the water outside of the case (910) is continuously supplied therein through the entrance (911), thereby generating the continuous flow of water.

In one embodiment illustrated in FIG. 1, a hooking portion (110) having predetermined length and height is provided along the upper surface of the mesh means (120) at a predetermined interval so as to prevent the green algae which got out of the water by the screen unit (100) from dropping back into the water.

The hooking portion (110) can also be configured to connect the both ends to each of the pair of base frames (115) so as to form a quadrangular closed space, and if the height of the base frames (115) is low, the hooking portion (100) can also be configured to protrude more than the base frames (115).

By applying such structure, the green algae which are caught by the mesh means (120) and got out of the water will not drop back into the water by the hooking portion (100).

In the second embodiment illustrated in FIG. 2, the structure of the mesh means (120) has been configured to have a plurality of layers instead of one layer, in order to maximize the effect of the screen unit (100) of removing the green algae.

In other words, the mesh means (120) comprises a first layer (121) having 50 to 400 meshes, a second layer (122) made of nonwoven fabric having a thickness of 5 mm to 10 mm, and a net-shaped third layer (123) having a predetermined thickness and being provided on the upper side of the second layer (122).

The third layer (123) of the mesh means (120) is positioned at the outermost and functions as fixing the second layer (122) being made of nonwoven fabric (porous fiber) so as to prevent the second layer (122) from leaving. In addition, the third layer (123) is formed in a net shape having a predetermined thickness and serves as a kind of a hooking portion (110) so that the green algae which were pulled out of the water by the first layer and the second layer do not slip off.

The net-shaped third layer (123) is to fix the second layer (122) and prevent the green algae from slipping off at the same time, not to finely filter the green algae. Thus, the third layer (123) preferably has smaller meshes than the first layer (121) (the smaller the meshes are, the larger the size of the holes is).

The second layer (122) is made of nonwoven fabric having a thickness of 5 mm to 10 mm. Out of nonwoven fabrics, applying air filter nonwoven fabric is preferable to maximize the effect of removing the green algae. The nonwoven fabric remains in the sheet shape because bundles of thin fibers are tangled, and the nonwoven fabric has a very high porosity, so the green algae which are present within the water come into the empty space inside of the nonwoven fabric, thereby coming out the water.

Herein, if the thickness of the second layer (122) is less than 5 mm, the amount of the adhered green algae is reduced, and if the thickness exceeds 10 mm, the green algae coming into the second layer (122) are not easily discharged during the operation of the first cleaning unit (200) and the second cleaning unit (300). Thus, the thickness of the second layer (122) is preferably between 5 mm and 10 mm.

The green algae coming into the second layer (122) are hooked on the first layer (121) having 50 to 400 meshes so they cannot pass through anymore, and are not easily separated by the third layer (123).

In addition, because the first layer (121) has 50 to 400 meshes, the holes are very fine, but the second layer (122) made of nonwoven fabric is relatively less fine because bundles of fibers are tangled. Thus, even if the green algae coming into the second layer (122) in the water try to be discharged out by its weight, the green algae cannot easily get out because they are hooked by the bundles of fibers. On the other hand, when the air is applied to the green algae by means of the first cleaning unit (200) and the second cleaning unit (300), they are easily separated after they are pulled out of the water.

The conveyer-type screen unit (100) illustrated in FIGS. 3 to 6 comprises several number of pairs of opposite rotation units (150) being positioned according to a predetermined direction and rotating by means of a driving means (140), and a mesh means (120) in a conveyer form surrounding the several number of rotation units (150) and rotating on an endless track by means of the rotation unit (150), the mesh means (120) with predetermined meshes pulling the green algae in the water out of the water as a part thereof is submerged into the water, wherein the driving means (140) and the rotation units (150) are connected by means of a chain (141), and the several number of the rotation units (150) are also connected by means of the chain (141).

Like the aforementioned drum-type, the first cleaning unit (200) and the second collecting unit (600) are positioned inside of the screen unit (100) rotating on an endless track and the screen unit (100) rotates separately from the first cleaning unit (200) and the second collecting unit (600).

Such conveyer-type screen unit (100) can also be configured to comprise the mesh means (120) straightly in parallel or make a part being bent in the manner where the plurality of rotation units (150) are placed so that the screen unit (100) can be submerged into the water.

The conveyer-type screen unit (100) may also comprise a water current generating unit (900) for generating the flow of water continuously, and the detailed configuration of the water current generating unit (900) is the same as explained above.

The conveyer-type screen unit (100) may also be provided with the mesh means (120) having the first layer (121), the second layer (122) and the third layer (123), and a hooking portion (110) can be provided on the upper surface of the mesh means (120).

Meanwhile, on one surface of the aforementioned first cleaning unit (200) and the second cleaning unit (300), a plurality of spraying holes (210) are formed, wherein the plurality of spraying holes (210) may make the row and column. The air sprayed through the spraying holes (210) is supplied by a separate compressor (not shown), but there is a difficulty in supplying the air continuously and the pressure could be reduced.

Thus, in order to increase the momentary spraying pressure, it is preferable that the air is sprayed alternatively through the plurality of spraying holes (210).

The first collecting unit (500) and the second collecting unit (600) that collect the green algae, which are removed from the first cleaning unit (200) and the second cleaning unit (300), comprise a housing (510) and a first filter unit (530).

The housing (510) forms the entire structure of the first collecting unit (500) and the second collecting unit (600), and can be implemented in various shapes and sizes depending on situations where the present invention is applied.

On the top of the housing (510), an inlet port (520) through which the green algae, which has been removed from the first collecting unit (500) and the second collecting unit (600), come into, and in its center, the first filter unit (530) having a net structure in which the green algae coming into through the inlet port (520) is provided.

The first filter unit (530) has a net structure such that the green algae cannot pass through but only the water can pass through, and in order to maximize the filtering effect, 50 to 400 meshes are preferably applied.

On the bottom of the housing (510), a lower discharge port (540) through which the water passing through the first filter unit (530) is discharged, and on its side, a plurality of side discharge ports (550) provided with a second filter unit (560) having a net structure are formed. The second filter unit (560) preferably has 50 to 400 meshes, and the side discharge ports (550) are preferably positioned higher than the filter unit so that the introduced water can be effectively discharged.

In other words, if the green algae is continuously stacked in the first filter unit (530), the amount of the water discharged through the first filter unit (530) would be reduced, and thereby the water introduced together with the green algae would rise in the housing (510). The water gathered on the top of the first filter unit (530) passes through the second filter unit (560) and is discharged through the side discharge port (550), and the water discharged through the lower discharge port (540) and the side discharge port (550) flows into rivers, streams, etc. where the present invention is located, through a separate discharge pipe (590) provided on the outside of the housing (510) since the green algae has been removed from the water.

As such, it is preferable that a plurality of side discharge ports (550) are formed apart from each other according to a height direction of the housing (510) so that the water introduced inside of the housing (510) can be effectively discharged.

Meanwhile, since the green algae coming into the first collecting unit (500) and the second collecting unit (600) hold certain amount of the water even after the water is discharged, the viscosity and the volume become relatively higher as the stacked amount increases.

Thus, a heater unit (570) for drying the green algae stacked in the first collecting unit (500) and the second collecting unit (600) is preferably provided.

The heater unit (570) for drying the green algae can have a hot wind device that jets warm wind, but since it consumes a lot of electricity, the maintenance costs may be expensive when applying it. Thus, it is preferable to dry the stacked green algae using a heating element such as a hot wire.

In the embodiment according to the present invention, orthogonal guide frames (580) that are perpendicular to each other are provided inside of the housing (510), and then a plurality of the first filter units (530) are mounted, and the heater unit (570) is provided inside of the guide frames (580), so that the heat is transferred to the guide frames (580) and the first filter units (530) to dry the stacked green algae.

Herein, the first filter unit (530) is preferably made of a metal material with high heat conductivity, and it is also possible to use the guide frame (580) itself as a heater unit (570) to dry the green algae.

Meanwhile, the removal apparatus for green algae according to the present invention preferably further comprises a solar battery unit (700) that supplies the power to the heater unit (570) so that the power consumption is not high even when the apparatus operates in rivers, streams, etc. continuously.

It is also more effective to actuate the driving means (140) by using the solar battery unit (700). However, since the power generated by the solar battery unit (700) is not great, the generated power is supplied to the heater unit (570) that consumes the power relatively less, and if the power is enough, it is preferable to actuate the driving means (140) with the generated power.

Herein, the solar battery unit (700) may be positioned on the top of the screen unit (100), thereby protecting the screen unit (100) from rain and snow, etc.

In addition, the removal apparatus for green algae according to the present invention preferably further comprises a brush unit (400) that contacts with the outer surface of the screen unit (100) and removes the green algae.

The brush unit (400) is positioned in the outer side of the screen unit (100) and rotates in the same direction as or different direction from the rotation direction of the screen unit (100), and as it directly contacts with the screen unit (100), it removes the green algae adhered on the surface of the screen unit (100).

The brush unit (400) not only serves as removing the green algae but also as reducing the adhesion of the green algae which are tightly adhered to the surface of the screen unit (100).

Accordingly, as shown in the embodiments of the present invention, the brush unit (400) can also be positioned between the first cleaning unit (200) and the second cleaning unit (300) and serves as improving the cleaning effect of the second cleaning unit (300) and directly removing the green algae at the same time, and it is also possible that the brush unit (400) is positioned before the first cleaning unit (200) or after the second cleaning unit (300).

The present invention has the following various effects:

First, the present invention can be used persistently by pulling the green algae floating in the water out of the water and removing them by using a first cleaning unit and a second cleaning unit.

Second, the present invention can be maintained and managed with minimum electricity consumption by operating a heater unit using a solar battery unit.

Third, the present invention can minimize the volume of the stacked green algae by drying the collected green algae using the heater unit, thereby increasing the stacked amount.

Fourth, the present invention can be manufactured at low costs and is easy to maintain and manage because its constitution is simple. For this reason, the invention can be utilized immediately in rivers and streams, etc.

Fifth, the present invention is excellent in removing green algae as the first cleaning unit and the second cleaning unit spray the air in different directions on the outside and inside of the screen unit.

Sixth, when the present invention is utilized in a place such as a reservoir where there is little flow of water, the effect of removing green algae can be maintained constant by generating the water current continuously using a water current generating unit.

While the present invention has been described with respect to the specific embodiments, it will be apparent to those skilled in the art that various changes and modifications may be made without departing from the spirit and scope of the invention as defined in the following claims.

What is claimed is:

1. A removal apparatus for green algae, comprising:
a screen unit that pulls the green algae out of the water by the rotation as a part thereof is submerged in the water, the screen unit having predetermined meshes;
a first cleaning unit that sprays the air in the direction from the inside of the screen unit to the outside;
a second cleaning unit that sprays the air from the outside of the screen unit to the inside;
a first collecting unit being positioned outside of the screen unit and in which the green algae removed by the first cleaning unit are stacked; and
a second collecting unit being positioned inside of the screen unit and in which the green algae removed by the second cleaning unit are stacked.

2. The removal apparatus for green algae according to claim 1, further comprising a driving means for rotating the screen unit, wherein the screen unit comprises a pair of base frames that are circular and opposite to each other, and a mesh means being positioned according to a circumferential direction of the pair of base frames, the mesh means having 50 to 400 meshes, and wherein the screen unit rotates separately from the first cleaning unit and the second collecting unit.

3. The removal apparatus for green algae according to claim 1, further comprising a driving means for rotating the screen unit, wherein the screen unit comprises a several number of rotation units being provided apart from each other and rotating by means of the driving means, and a mesh means in a conveyer form surrounding the several number of rotation units and rotating on an endless track, the mesh means having 50 to 40 meshes, and wherein the screen unit rotates separately from the first cleaning unit and the second collecting unit.

4. The removal apparatus for green algae according to claim 1, wherein on the surface of the screen unit, a hooking portion that prevents the green algae from leaving is protruding at a predetermined interval along the outer circumference surface of the screen unit.

5. The removal apparatus for green algae according to claim 1, wherein on the outside of the screen unit, a brush unit which contacts with the outer surface of the screen unit and removes the green algae while rotating is provided.

6. The removal apparatus for green algae according to claim 1, wherein the first collecting unit and the second collecting unit comprises:
a housing, and
a first filter unit having a net structure, being positioned in the housing and in which the green algae are stacked, wherein the green algae and the water are separated by the weight,
wherein on the top of the housing, an inlet port through which the green algae come into is provided, on the bottom, a bottom discharge port through which the water passing through the filter unit is discharged is formed, and on the side, a plurality of side discharge ports provided with a second filter unit having a net structure is formed, wherein the side discharge ports are positioned higher than the filter unit.

7. The removal apparatus for green algae according to claim 6, wherein the first collecting unit and the second collecting unit further comprise a heater unit that dries the stacked green algae.

8. The removal apparatus for green algae according to claim 7, further comprising a solar battery unit that supplies the power to the heater unit.

9. The removal apparatus for green algae according to claim 1, wherein in the first cleaning unit and the second cleaning unit, a plurality of spraying holes are formed, and the air is sprayed alternatively through the plurality of the spraying holes.

10. The removal apparatus for green algae according to claim 2, wherein at one side of the screen unit submerged into the water, a water current generating unit that generates the flow of water is provided, wherein the water current generating unit comprises a case with an inlet through which the water is introduced while surrounding a part of the screen unit being submerged into the water, and an outlet through which the water is discharged, and a suction means being connected to the entrance and generating the suction force.

11. The removal apparatus for green algae according to claim 3, wherein at one side of the screen unit submerged into the water, a water current generating unit that generates the flow of water is provided, wherein the water current generating unit comprises a case with an inlet through which the water is introduced while surrounding a part of the screen unit being submerged into the water, and an outlet through which the water is discharged, and a suction means being connected to the entrance and generating the suction force.

12. The removal apparatus for green algae according to claim 2, wherein the mesh means comprises a first layer having 50 to 400 meshes, a second layer being positioned on the top of the first layer and being made of nonwoven fabric having a thickness of 5 mm to 10 mm, and a net-shaped third layer having a predetermined thickness and being provided on the top of the second layer.

13. The removal apparatus for green algae according to claim 3, wherein the mesh means comprises a first layer having 50 to 400 meshes, a second layer being positioned on the top of the first layer and being made of nonwoven fabric having a thickness of 5 mm to 10 mm, and a net-shaped third layer having a predetermined thickness and being provided on the top of the second layer.
